(19) United States
(12) Patent Application Publication
(10) Pub. No.: US 2017/0225252 A1
(43) Pub. Date: Aug. 10, 2017

(54) ADDITIVE MANUFACTURING

(71) Applicant: MATERIALS SOLUTIONS LIMITED, WORCESTER (GB)

(72) Inventors: TREVOR ILLSTON, WORCESTER (GB); PRATIK YATIN VORA, WORCESTERSHIRE (GB)

(21) Appl. No.: 15/242,776

(22) Filed: Aug. 22, 2016

(30) Foreign Application Priority Data
Aug. 28, 2015 (GB) 1515390.1

(51) Int. Cl. B23K 7/06; B33Y 40/00; B33Y 10/00; B23K 26/342; B23K 28/02

(52) U.S. Cl. CPC B23K 7/06; B23K 26/342; B23K 28/02; B33Y 10/00; B33Y 40/00

(57) ABSTRACT

A method is for reducing surface roughness of an additive manufactured metallic component. The method includes placing the component in a chamber, filling the chamber with a combustible gas mixture, allowing the gas mixture to surround the component and igniting the gas mixture so as to expose the surface of the additive manufactured metallic component to at least one thermal pulse.

### BACKGROUND

The present invention relates to additive manufactured metallic components and in particular to methods of improving surface roughness of an additive manufactured metallic component.

Additive Manufacturing is a group of processes characterised by manufacturing three-dimensional components by building up substantially two-dimensional layers (or slices) on a layer by layer basis. Each layer is generally very thin (for example between 20 to 100 microns) and many layers are formed in a sequence with the two dimensional shape varying on each layer to provide the desired final three-dimensional profile. In contrast to traditional “subtractive” manufacturing processes where material is removed to form a desired component profile, additive manufacturing processes progressively add material to form a net shape or near net shape final component.

The earliest Additive Manufacturing processes, such as Stereolithography, were based upon the curing of photo-polymers using UV light and several techniques exist for forming plastic parts (including so called “3D printing” which is typically used to refer to Additive Manufacturing of plastics based upon modified inkjet type printing methods).

The Additive Manufacturing of metals presents significantly different issues to that of plastics and may be considered a distinct field by those skilled in the art. Metal powder bed additive Manufacturing techniques are all based upon the basic principle of building a “slice” based upon a 3D CAD file by directing a point source of energy across the surface of a layer of metal powder. The energy spot is of sufficient intensity to locally melt (or sinter) the powder layer where it strikes it and creates a liquid melt pool (typically of a depth of that layer and at least half of the underlying layer of powder or, if there is a solid layer underneath, some of that underlayer). As the energy spot moves on (directed by the optics of the Additive layer manufacturing machine) the melt pool cools and the metal re-solidifies creating a contiguous whole of that layer and the underlayers. Upon completion of a layer, a new layer of powder is provided to allow the next slice to be formed.

Alternative metal Additive Manufacturing techniques may use powder (or wire) melted and applied as a liquid by mechanically scanning across a workpiece.

The point source of energy may for example be a laser or electron beam and several commercially available powder bed metallic additive manufacturing systems are known. For example including methods known and/or trade marked as ‘selective laser sintering’, selective laser melting, Laser Cusing® and DMLS®. Examples of commercially available additive manufacturing machines for producing metallic components include, for example, selective laser machines include the EOS M2XX or M4XX series (produced by EOS GmbH) and electron beam machines such as those produced by Acram AB of Sweden.

Additive manufacturing is capable of producing extremely complex parts at close to “net shape” but it will be appreciated by those in the art that support structures are generally required during manufacture. The support structures are integrally formed along with the component during additive manufacture on a layer-by-layer basis. For example, support structures may be required to sustain overhanging parts/surfaces. Support structures are particularly important in metallic components (especially high strength metals) since the heating and cooling necessary in the additive process creates residual stresses within the part which have the potential to causes geometric distortion and/or cracking of the part.

Support structures must be carefully designed and optimised during the pre-manufacturing process so as to be attached to the component with sufficient mechanical strength to function as intended, but also be relatively easy to remove after manufacture. Typically, the support structures may include a distinct interface region where they meet the component which has a lattice or toothed profile to provide a clearly defined separation line to the component. However, particularly for high performance metals (such as superalloys), the interface must be very strong and as a result the supports structure is difficult to remove. Sharp cutting tools are used with considerable force and there is a danger that the surface of component may be damaged during this removal process.

After the removal of the support structure the interface surfaces of the component may exhibit some remnants of the interface resulting in an undesirable increased surface roughness. Additionally, downward facing surfaces may typically exhibit a degree of inherent roughness as a result of unintended powder melting below the layer desired.

### SUMMARY

Thus, there is a need for further methods for reducing the surface roughness of metallic components produced by additive manufacturing.

According to a first aspect of the invention there is provided a method of reducing surface roughness of an additive manufactured metallic component, the method comprising: placing the component in a chamber, filling the chamber with a combustible gas mixture, allowing the gas mixture to surround the component igniting the gas mixture so as to expose the surface of the additive manufactured metallic component to at least one thermal pulse. This method enables the smoothing of an additively manufactured surface that can't be accessed using conventional methods to modify the surface of a component, for example using lasers that require ‘line of sight’ of the surface to be altered/smoothed.

After the thermal pulse the method may further comprise abrasively cleaning the surface of the component.

In accordance with a second aspect of the invention, there is provided a method of additive manufacturing metallic components, the method comprising the steps of:

forming a component in a layer-by-layer process; removing any support structure(s) formed during the layer-by-layer process; and

reducing surface roughness of the additive manufactured metallic component by exposing the surface of the additive manufactured metallic component to at least one thermal pulse. The method may further comprise abrasively cleaning the surface of the component.

The abrasive cleaning step may for example comprise abrasive blasting.

A plurality of thermal pulses may be applied (for example in succession during a single process) prior to the abrasive cleaning.

The applicants have, surprisingly, found that the application of a thermal pulse prior to abrasive cleaning of the surface provides an improved surface finish by reducing surface roughness. For example, when the method of an embodiment was applied to test pieces by the applicant it was that the combination of applying at least one thermal pulse followed by an abrasive process demonstrated a reduce surface roughness (Ra measurement), measured using a surface profilometer, of at least 30% and typically 50% to 60%.

For example, an embodiment of the invention may reduce surface roughness resulting from remnants of the support structure interface or surface roughness of downward facing surfaces (which those in the art will appreciate may typically exhibit a degree of inherent roughness as a result of unintended powder melting below the layer desired).

Further—powder bed additively manufactured parts before surface finishing have a covering of sintered-on metal powder—the edge of the formed part being defined by insufficient heat to fully melt the powder. The next metal powder particle then been sintered on- joined by a narrow ‘neck’. These sintered-on powder particles are conventionally removed by mechanical finishing—e.g. abrasive blasting. However, the applicants have now discovered that a thermal pulse before abrasive blasting leads to a smoother surface after blasting. It is believed this may result from the narrow ‘neck’ joining the sintered particle to the fully melted part being further narrowed. It can also be appreciated that a plurality of thermal pulses could be continued such that many or most sintered-on particles are removed.

The abrasive cleaning removes residual sintered-on metal powder particles and the oxide resulting from earlier heat treatments and that produced by the thermal pulse treatment. Whilst not being bound by any particular theory, it is believed that the combination of the thermal pulse and subsequent abrasive treatment is particularly advantageous by at least partially oxidising, vaporising or melting the local fine peaks in the surface to enable or encourage their selective removal during the subsequent abrasive treatment. In contrast, the thermal pulse may be sufficiently short in duration to result in substantially less heating away from the local fine peaks since the component is not bulk heated.

The thermal pulse may be at a temperature exceeding the melting point of the metallic material. The thermal pulse may provide a peak temperature increase of at least 2000° C., for example an increase of between approximately 2500 to 3500° C.

The gas mixture may be a mixture of a hydrocarbon (for example methane) and oxygen (which may for example be provided as air). The chamber may be at an increased atmospheric pressure (for example 400 bar and peak pressure during combustion may for example reach 2000 bar or more).

The combustion of the gas mixture may be such that the thermal pulse is an explosive or pseudo-explosive ignition.

The thermal pulse may be of insufficient duration to bulk heat the component. The thermal pulse may for example be of less than 100 milliseconds in duration, for example less than 20 milliseconds in duration.

As the thermal pulse is of a relatively short duration the thermal conductivity into the bulk of the component is low. For example, due to the very short duration, the bulk component temperature may increase by only less than 200° C., for example by between approximately 50-150° C.

A thermal pulse may additionally be applied to the component after additive manufacture and prior to separation of the component from its support structure (which is integrally formed during the layer-by-layer additive process). This has been found to weaken- and some cases break- the interface between the component and support structure and thereby enable or aid removal.

The separation of the support from the component, after application of the thermal pulse, may be by conventional means.

The support may comprise a bulk support and the interface comprises a plurality of interface support members connecting between the bulk support and the component. During the process the interface support members are weakened—and in some cases may be broken—by the thermal pulse prior to subsequently being removed (for example cut)by the mechanical removal.

The applicants have found that subjecting the component and support structure to a thermal pulse reduces the strength of the interface between the support structure and component without having any notable adverse effect on the material properties of the component.

Without being bound by any particular theory it is believed that the thermal pulse causes a localised (or selective) vaporisation, oxidation or melting of narrow features with poor thermal conductivity. Thus, the fine interface between a bulk support and a part- and between a sintered on metal powder particle and the part- is weakened and removal by conventional means is easier.

The step of exposing the component and support structure to a thermal pulse comprises placing the component and support structure in a chamber, filling the chamber with a combustible gas mixture, allowing the gas mixture to surround the component and support structure and igniting the gas mixture. By allowing the gas mixture to fully mix with the structure and support prior to ignition the gas mixture may permeate any open spaces or voids within the component and support structure before combustion. In particular the gas mixture is able to permeate into the spaces or voids surrounding the interface.

The metallic component and support structure may be formed on a baseplate. As will be appreciated by those skilled in the art the component and support structure may essentially be welded to the baseplate during the additive manufacture process (as the first layer is formed on the baseplate).

Prior to application of the method in accordance with embodiments of the invention (and optionally before removal of the support structure from the additive manufactured metallic component) the metallic component may be heat treated to remove or reduce residual stresses induced the layer-by-layer process. In order to avoid distortion due to residual stress such heat treatment may be carried out prior to the removal of the component from the baseplate. The support structure and metallic component may be removed from the baseplate together and as such the heat treatment may take place prior to the removal of the support structure.

It will be appreciated that a plurality of components and associated support structures may be formed on a single baseplate prior during a single additive process (and this would not impact the applicability of the present invention).

The skilled person will appreciate that the step of heat treating the additive manufactured component (typically whilst still attached to the base plate) is a known process for the removal/reduction of residual stress and is distinct from the thermal pulse of embodiments of the invention. For example, such heat treatment is typically carried out in under inert or vacuum atmospheric conditions (i.e. a non-oxidising environment). Further the heat treatment must be at a temperature below the melting point of the metallic material. During such heat treatment processes bulk heating (but not melting) of the component is intended to occur.

The additive manufacturing process in accordance with embodiments of the invention may comprise powder bed selective laser manufacturing.

Alternatively in a further aspect of the invention there is provided a method of reducing surface roughness of an additive manufactured metallic component, the method comprising: exposing the surface of the additive manufactured metallic component to at least one thermal pulse.

Whilst the invention has been described above, it extends to any inventive combination of features set out above or in the following description or drawings. Further, any optional features described above with respect to embodiments of the first aspect of the invention are expressly considered to be equally applicable to the second aspect of the invention and visa versa.

### BRIEF DESCRIPTION OF THE DRAWINGS

Specific embodiments of the invention will now be described in detail, by way of example only, and with reference to the accompanying drawings in which:

FIG. 1 is a schematic representation of a part manufactured by a conventional additive manufacturing method;

FIG. 2 shows examples metal parts formed by additive manufacturing with support structures both present and removed;

FIG. 3 shows a flow chart for the forming an additive manufactured component in accordance with embodiments of the invention; and

FIG. 4 shows a series of images (at varying magnification) of the surface of a metallic component formed in a powder bed process prior to treatment of the surface.

### DETAILED DESCRIPTION OF EMBODIMENTS

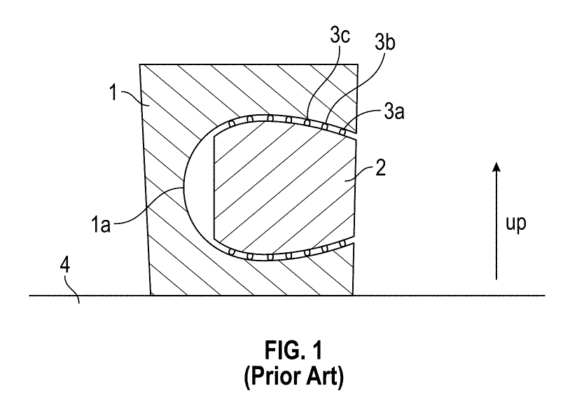

A schematic representation of a metal part 1 manufactured in an additive manufacturing method is shown in FIG. 1. The metal part is for example a casing and includes a cavity la within its body. The part 1 is formed by being built up on a layer-by-layer manner on a baseplate 4 in a manner which will be well known to those skilled in the art.

A bulk support structure 2 is provided within the cavity la of the part 1. The bulk support is arranged to be built relatively quickly during the additive layer manufacture but to have sufficient strength to resist the loads from the part 1 and, for example to resists geometric distortion of the part 1. The skilled person will appreciate that the support 2 may have any convenient (optimised) form and could be a solid or for example a lattice or honeycomb structure.

To ensure that the support 2 can be removed from the component 1 after manufacture it is provided with an interface 3 which forms a distinct “break line” between the support 2 and component 1. The interface may comprise a number of distinct, tooth like, interface members 3a, 3b, 3c which join the component 1 and support 2. It will be appreciated that the component 1, support 2 and interface 3 are all integrally formed on a layer-by-layer basis during the additive manufacturing process.

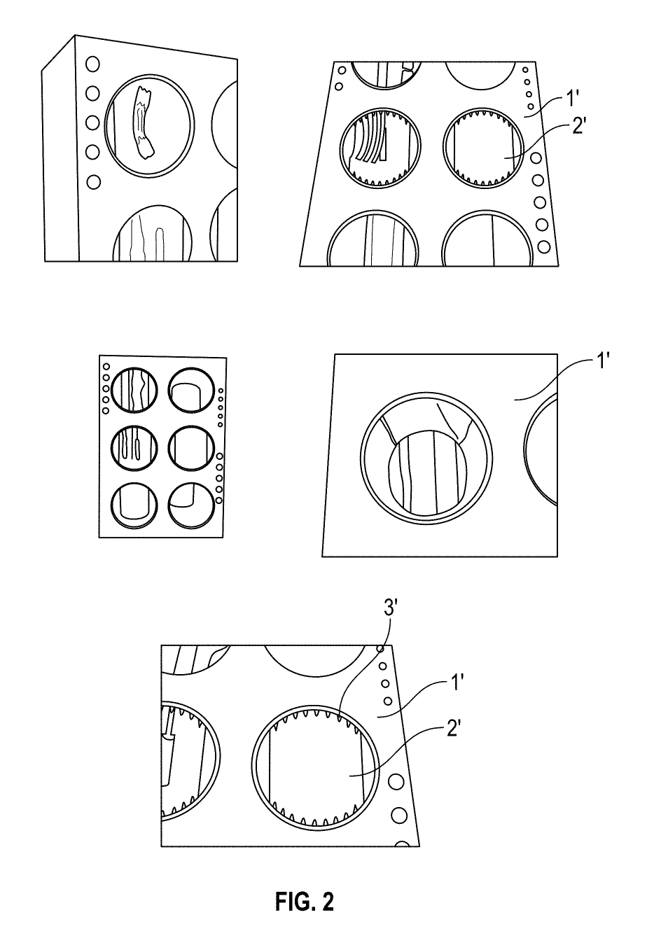

Some example photographs are shown in FIG. 2 to illustrate the removal of a support structure 2′ from a component 1′ using the method in accordance with embodiments of the invention. It may be noted that the photographs show the support 2′ both in situ, partially removed and after removal (with remnants of the interface showing).

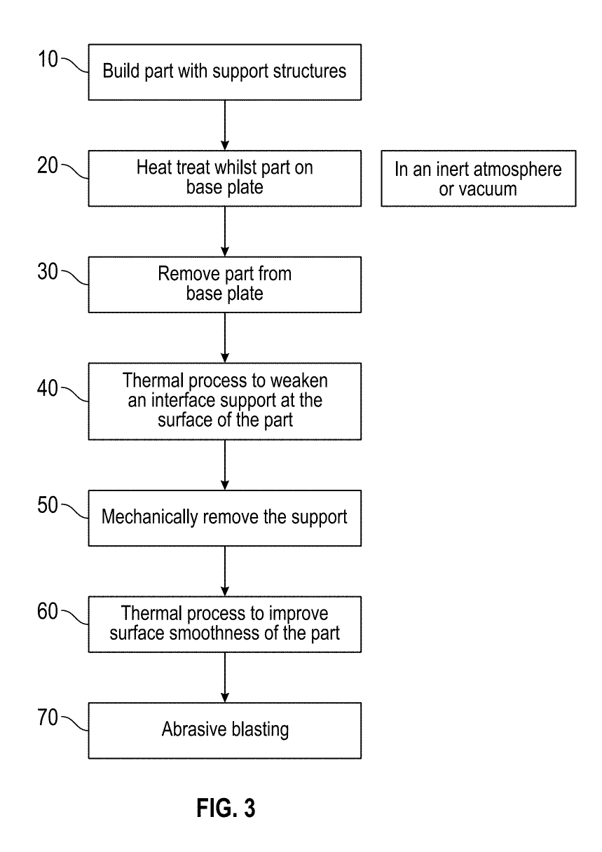

The method in accordance with an embodiment of the invention is shown by the flow chart of FIG. 3. In the initial step 10 a component is built along with support structures by a known metallic additive manufacture process. A subsequent heat treatment 20 is applied to the part after removal from the additive layer manufacturing machine (but with the part remaining attached to the baseplate to resist deformation. This heat treatment is in a non-oxidising atmosphere (inert or vacuum) and is intended to reduce or minimise residual stresses.

With the residual stresses reduced by the heat treatment process 20, the component may processed 30 to remove it from the baseplate (but will still have associated support structure attached or embedded within it).

After this removal the part and support structure may optionally be subjected to a thermal pulse process 40 to weaken the interfaces between the support and component. This thermal pulse is carried out in a sealed chamber at increased pressure. The chamber is filled with methane and air which is allowed to fully surround the component prior to ignition to provide extremely rapid and high temperature combustion (an explosive or pseudo explosive process). The thermal pulse may for example last approximately 20 milliseconds and result in an increase in temperature within the chamber of between 2500° C. and 3500° C. and a pressure spike of up to 2000 bar. The heat will strike the surfaces of the component and support structure but is of insufficient duration to cause bulk heating thereof. The thermal pulse step may for example be carried out using a conventional thermal deburring apparatus.

The thermal pulse step 40 has been found to weaken the interface parts 3 of the support 2 but since it does not cause any bulk heating of the component 1 it does not cause any change in its material properties. In contrast the interface parts are assumed to have a greater thermal conductivity so experience more significant surface oxidation and/or vaporisation and/or melting during the thermal pulse. This has been found to have provide a significant weakening of the interface and aid removal of the support (in step 50 below)

After the heat treatment and optional thermal pulse step 40, the support 50 using any convenient mechanical processing step 50 (and the skilled person will appreciate that the particular mechanical process selected may depend upon several factors such as the material and geometry of the component and support).

Once the support has been fully removed it is normal to apply a final abrasive cleaning step 70 such as abrasive blasting to remove any remaining remnants of the interface members 3 from the separated component 1. In accordance with an embodiment prior to such abrasive blasting the component may be subjected to a further thermal pulse step 60. The thermal pulse step 60 may include the application of a plurality of thermal pulses.

It has surprisingly been found that the application of this additional step 70 (thermal pulse followed by abrasive blasting) produces a greater reduction in surface roughness than abrasive blasting alone—and in fact is so effective could be used alone if, for example, oxide removal is not required. This appears to go directly against the teaching in the art since an advantage of utilising thermal pulses in known processes such as thermal deburring is that component surfaces are not affected. When the method of an embodiment was applied to test pieces by the applicant it was found to demonstrate a reduce surface roughness (Ra measurement), measured using a surface profilometer following the subsequent abrasive blasting process 70, of at least 30% and typically 50% to 60%.

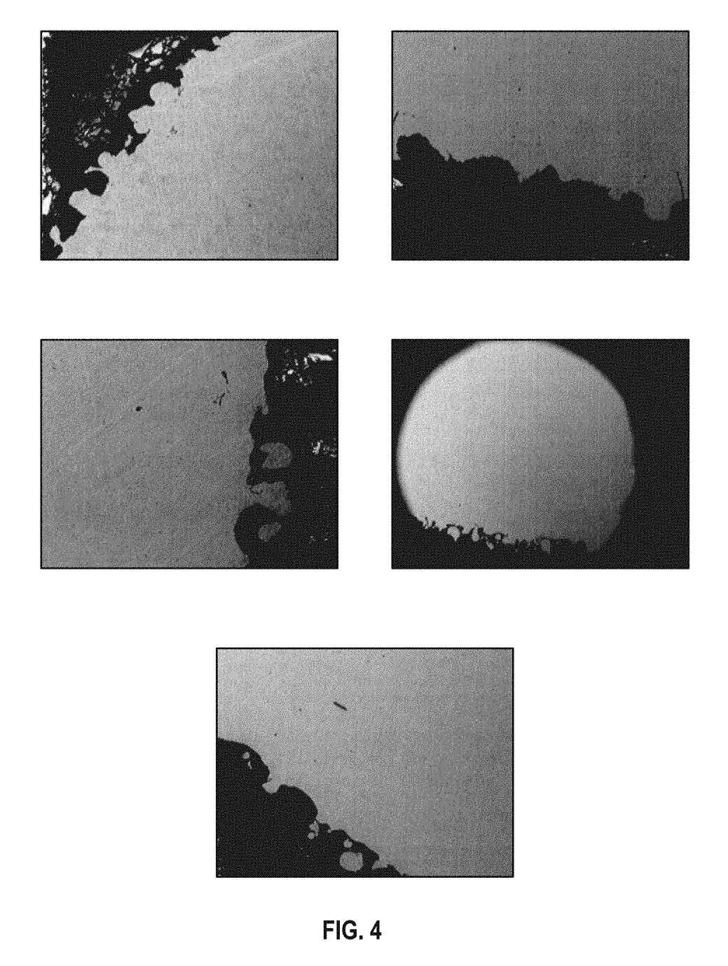

To help illustrate the effect of the invention, FIG. 4 shows a close-up view of a metal powder-bed component surface before any treatments of the surface. It can be seen that additional unwanted material in the form of sintered-on metal powder causes undesirable surface roughness. The origin of the material as being formed from metal powder is clear—the heat affected zone around the melt pool created by the point source of heat causes powder to sinter(but not fully melt)-onto the surface. As the powder bed is approximately 50% dense and the powder is generally spherical the resultant surface viewed locally is relatively speaking very rough—and very different from a surface formed by any other process such as a cutting, grinding, moulding or electro-discharge machining process.

It is important to note, and will be appreciated by those skilled in the art, that no burrs are present on the additively manufactured surfaces being described here and therefore a deburring process is not required. Burrs result from cutting processes and the process described here results in a reduction in surface roughness when applied before any cutting processes.

Without being bound to any particular theory, the applicants believe that the reduction in surface roughness is a result of the residual high points of the interface between a support (and the narrowing of neck between a sintered-on metal powder particle, and for example high points of roughness on downward faces) being vaporised, oxidised or melted by the thermal pulse creating a selectivity to the process and thereby enabling a smoothing to take place. The surface oxide than results from the earlier heat treatment and thermal process is then preferably removed by abrasive blasting.

Although the invention has been described above with reference to a preferred embodiment, it will be appreciated that various changes or modifications may be made without departing from the scope of the invention as defined in the appended claims. For example, the reduction in surface roughness resulting from the thermal pulses may be sufficient and a mechanical smoothing and removal of surface oxide is not required- thus saving time and expense.

What is claimed is:

1. A method of reducing surface roughness of an additive manufactured metallic component, the method comprising:
placing the component in a chamber, filling the chamber with a combustible gas mixture, allowing the gas mixture to surround the component and igniting the gas mixture so as to expose the surface of the additive manufactured metallic component to at least one thermal pulse.

2. The method of claim 1, wherein the step of exposing the surface of the additive manufactured metallic component to at least one thermal pulse comprises exposing the surface to a plurality of thermal pulses.

3. The method of claim 1, wherein surface oxides are removed by abrasively cleaning after the thermal pulse.

4. The method of any of claims 1, wherein improving the surface roughness of an additive manufactured metallic component comprises smoothing the surface roughness caused by remnants of support structures formed during the additive manufacturing process.

5. The method of claim 1, wherein the thermal pulse is at a temperature exceeding the melting point of the metallic material.

6. The method of claim 1, wherein the thermal pulse is an explosive or pseudo-explosive ignition.

7. The method of claim 1, wherein any support structures formed during additive manufactured are removed from the metallic component prior to application of the method of improving surface roughness.

8. The method of claim 1, wherein the metallic component is heat treated prior to application of the method of improving surface roughness

9. A method of additive manufacturing metallic components, the method comprising the steps of:
forming a component in a layer-by-layer process;
removing any support structure(s) formed during the layer-by-layer process; and
reducing surface roughness of the additive manufactured metallic component in accordance with the method of claim 1.

10. The method of claim 1, wherein the additive manufacturing process comprises powder bed selective laser manufacturing.

11. The method of claim 9, wherein the additive manufacturing process comprises powder bed selective laser manufacturing.
